(19) United States
(12) Patent Application Publication
(10) Pub. No.: US 2016/0341303 A1
(43) Pub. Date: Nov. 24, 2016

(54) STEPPED PLANETARY GEAR WITH INNER BEARING

(71) Applicants: ZF FRIEDRICHSHAFEN AG, Friedrichshafen (DE); ZF WIND POWER ANTWERPEN N.V., Lommel (BE)

(72) Inventor: Wim SMET, Temse (BE)

(21) Appl. No.: 15/110,788

(22) PCT Filed: Dec. 15, 2014
(86) PCT No.: PCT/EP2014/077699

§ 371 Date: Jul. 11, 2016

(30) Foreign Application Priority Data
Jan. 16, 2014 (DE) 10 2014 200 675.9

(51) Int. Cl. F16H 57/08; F16C 33/66; F16C 19/36; F16C 19/54; F16H 57/04; F16C 19/38

(52) U.S. Cl. CPC F16H 57/08; F16H 57/0479; F16C 19/381; F16C 19/364; F16C 19/547; F16C 33/6677; F16H 2057/085; F16C 2361/61

(57) ABSTRACT

A stepped planetary gear (101) with at least an outer bearing surface of a first planetary bearing (115). The stepped planetary gear (101) is designed, at least partially, as a hollow shaft. The outer bearing surface of the first planetary bearing (115) is positioned, at least partially, inside of the hollow shaft.

This application is a National Stage completion of PCT/EP2014/077699 filed Dec. 15, 2014, which claims priority from German patent application serial no. 10 2014 200 675.9 filed Jan. 16, 2014.

### FIELD OF THE INVENTION

The invention concerns a stepped planetary gear.

### BACKGROUND OF THE INVENTION

FIG. 1 shows the construction of a known stepped planetary gear 101 as in the state-of-the-technology, The stepped planetary gear has a first stepped gear 103 and a second stepped gear 105. The first stepped gear 103 meshes with the ring gear 107. The second stepped gear 105 meshes with a sun gear 109.

The first stepped gear 103 and the second stepped gear 105 are rotationally fixed on a planetary shaft 111. This means that the first stepped gear 103, the second stepped gear 105 and the planetary shaft 111 cannot be rotated relative to each other, relative to a common rotation axis 113. Also, the first stepped gear 103, the second stepped gear 105 and the planetary shaft 111 are fixed in translation relation to each other. Thus, translational shifting of the first stepped gear 103, of the second stepped gear 105, and of the planetary shaft 111, relative to each other, is not possible.

By means of a first planetary bearing 115 and a second planetary bearing 117, the planetary shaft 111, and therefore also the first stepped gear 103 and the second stepped gear 105, are rotatably supported by a planetary carrier—not shown in FIG. 1. Hereby, the inner rings of the first planetary bearing 115 and of the second planetary bearing 117 are fixed in position on the planetary shaft 111. The outer rings of the first planetary bearing 115 and the second planetary bearing 117 are fixed in position on the planetary carrier. It is required that the first planetary bearing 115, the first stepped gear 103, the second stepped gear 105, and the second planetary bearing 117 are positioned offset relative to each other in the axial direction.

In particular, wind power installations are exposed to strong power loads during operation. This causes strong torsions in the area of the planetary carrier. In conventional planetary stages of wind power installations, the planetary bolts are therefore fixed in position in the planetary carrier by means of a press fit. For that reason, the planetary bolts contribute to the stability of the planetary carrier.

However, in the stepped planetary gear 101 in accordance with FIG. 1, the first planetary bearing 115 and the second planetary bearing 117 are the points of connection between the planetary shaft 111 and the planetary carrier. The planetary shaft 111 therefore, cannot stabilize the planetary carrier. Otherwise, the first planetary bearing 115 and the second planetary bearing 117 would be exposed to high loads.

Furthermore, in the planetary step in accordance with FIG. 1, it is not possible to use bearings, such as the first planetary bearing 111 and a second planetary bearing 117, which are operated with a preload. Also, the axial play of the first planetary bearing 115 and the second planetary bearing 117 cannot be adjusted.

### SUMMARY OF THE INVENTION

It is the task of the invention, through bypassing the inherent disadvantages of the known solutions in the state-of-the-art, to support a stepped planetary gear rotatable in a planetary carrier.

This task is solved through a stepped planetary gear having the characteristics as described below.

A stepped planetary gear is a planetary wheel with two, positioned coaxially toward each other, interlocking toothings, or rather with two, coaxially positioned to each other, stepped wheels called gear wheels. The first of both stepped wheels is designed to mesh with the ring gear. The second stepped gear is designed to mesh with the sun gear. In particular, the first stepped gear does not mesh with the sun gear. The second stepped gear does not mesh with the ring gear.

The stepped planetary gear, in accordance with the invention, is formed as a hollow shaft. This means that the stepped planetary gear includes the hollow shaft. The stepped planetary gear is—in other words—at least partially designed as a hollow shaft. The first stepped gear and the second stepped gear of the stepped planetary gear are connected with the hollow shaft in a rotationally fixed manner. In particular, torsion of the first stepped gear, of the second stepped gear and the hollow shaft, around the rotational axis of the stepped planetary gear and relative to each other, is not possible.

Preferably, the first stepped gear, the second stepped gear and the hollow shaft, are also completely translationally fixed relative to each other, as well as relative to a planetary carrier. This means that translational movement of the first stepped gear, the second stepped gear and the hollow shaft relative to one another as well as relative to the planet carrier is not possible,

The first stepped gear, the second stepped gear and the hollow shaft can be integrally connected with each other as at least three parts, two parts, or as one part.

In addition, the stepped planetary gear has at least an outer bearing surface of a first planetary bearing. The outer bearing surface of a bearing is to be understood as the bearing surface which forms the outer ring of the bearing. The bearing surface which is created by the inner ring of the bearing, is accordingly the inner bearing surface of the bearing. Therefore, the outer bearing surface extends around the inner bearing surface. The inner bearing surface is located at least partially within a cavity with two openings, surrounded by the outer bearing surface. The outer bearing surface and the inner bearing surface serve for roller bearings as bearing surface. Hereby, the rolling elements are located between the outer bearing surface and the inner bearing surface. In the case of slide bearings, a lubricant film is present, instead of the roller elements, between the outer bearing surface and the inner bearing surface.

It in accordance with the invention, the outer bearing surface of the first planetary bearing is located at least partially in the inner part of the hollow shaft, The inner part of the hollow shaft is marked as a cavity in the hollow shaft or surrounded by the hollow shaft, respectively, with two openings or outlets, respectively. The cavity is limited by the hollow shaft and by the two openings or outlets, respectively. Thus, it is a continuous recess. In particular, the cavity can be rotationally symmetric with an axis of symmetry, which runs along the rotation axis of the stepped planetary gear and is therefore identical with the rotational axis of the stepped planetary gear.

A hollow shaft is a shaft with the cavity as described above.

The inventive stepped planetary gear is suitable for application in a stepped planetary gear, in particular in a stepped planetary gear of a wind powered installation. A planetary gear train, or an epicyclic transmission, respectively, is described as a stepped planetary gear, which can have upstream transmission sections or can have transmission sections downstream.

The stepped planet is integrated in a way that the first step gear of the stepped planetary gear meshes exclusively with a ring gear, in particular not with a sun gear. The second stepped gear of the stepped planetary gear meshes exclusively with the sun gear, in particular not with the ring gear.

The stepped planetary gear has at least one planetary bolt. An inner ring of the first planetary bearing is positioned on the planetary bolt. In particular, the planetary bolt firmly fixes the inner ring of the planetary bearing in the radial direction. Preferably, the inner ring of the first planetary bearing is also completely fixed on the planetary bolt, meaning that between the inner ring of the planetary bearing and the planetary bolt no relative movement is possible.

Due to the installation of the inner ring of the first planetary bearing on the planetary bolt, the stepped planetary gear is rotatably supported on the planetary bolt. Therefore, the stepped planetary gear can be rotated, relative to the planetary bolt, around a rotation axis. Translational movements of the stepped planetary gear in relation to the planetary bolt are not possible.

Through the positioning of the outer bearing surface of the first planetary bearing, at least partially in the interior of the hollow shaft, support of the stepped planetary gear on the planetary bolt is made possible through the installation of the inner ring of the first planetary bearing on the planetary bolt, This, in return, allows fixing the planetary bolt in the planetary carrier so that the planetary bolt can contribute to the stabilization of the planetary carrier.

In particular, the planetary bolt can extend through the hollow shaft. This means that at least a first part of the planetary bolt is located at the outside of the hollow shaft, while a second part of the planetary bolt is located inside of the hollow shaft. Preferably and on top of it, additionally, a third part of the planetary bolt is located outside of the hollow shaft. The planetary bolt can be firmly fixed to the planetary carrier in the first part and/or the third part of the planetary bolt. The second part serves for accommodating the planetary bearings.

The planetary bolt is at least connected in the planetary carrier in a rotationally fixed manner, so that torsion of the planetary bolt, relative to the planetary carrier, is prevented. Preferably, the planetary bolt is immovably fixed in the planetary carrier, meaning that no rotational and no translational relative movement is possible between the planetary bolt and the planetary carrier.

Due to the positioning of the outer bearing surface of the first planetary bearing, at least partially in the interior of the hollow shaft, the first planetary bearing can additionally be positioned or fixed by means of the planetary bolt in the axial direction. That can be accomplished in particular through the use of cylindrical or tapered roller bearings as the first planetary bearing.

In a further, preferred embodiment, the stepped planetary gear has at least an outer bearing surface of a second planetary bearing. It is positioned at at least partially in the inside of the hollow shaft. In addition, the above descriptions are also valid with regard to the outer bearing surface of the first planetary bearing mutatis mutandis (applicable) for the outer bearing surface of the second planetary bearing.

A further, a third embodiment of the stepped planetary gear has accordingly an inner ring of the second planetary bearing which is positioned on the planetary bolt. Furthermore, the description above is valid concerning the inner ring of the first planetary bearing, mutatis mutandis (applicable) for the inner ring of the second planetary bearing.

Also preferred is a configuration in which the inner ring of the first planetary bearing and/or the inner ring of the second planetary bearing are positioned at least partially inside the first hollow shaft. It accommodates a compact configuration of the standard planetary and allows in particular an especially rigid connection between the planetary bolt and the planetary carrier.

Another configuration is preferred for the same reason, where the outer bearing surface of the first planetary bearing and/or the outer bearing surface of the second planetary bearing and/of the inner bearing surface of the first planetary bearing and/or the inner bearing surface of the second planetary bearing are completely inside of a hollow shaft

In a further, preferred embodiment of the stepped planetary gear, the outer bearing surface of the first planetary bearing and/or the outer bearing surface of the second planetary bearing are integrated as one part in the hollow shaft. Thus, the hollow shaft forms the outer bearing surface of the first planetary bearing and/or the outer bearing surface of the second planetary bearing. In particular, also the outer ring of the first planetary bearing and/or beholder ring of the second planetary bearing are integrated as one part in the hollow shaft.

The stepped planetary gear, in accordance with the invention enables providing the first planetary bearing and/or the secondary planetary bearing with a lubrication carrier duct, which extends to the planetary bolt. In an especially preferred embodiment, the stepped planetary gear has a planetary bolt with at least one channel for supplying the first planetary bearing and/or the second planetary bearing with lubricant.

The channel is designed in a way so that the lubricant, between the first planetary bearing and the second planetary bearing, exits into at least a cavity which is formed by the planetary bolt, the stepped planetary gear, the first planetary bearing and/or the second planetary bearing, From there, the lubricant material flows into the first planetary bearing and/or the second planetary bearing.

### BRIEF DESCRIPTION OF THE DRAWINGS

In the following, more details of the embodiment examples of the invention can be found in FIG. 2a to 4b. FIG. 1 shows the state-of-the-art. Matching reference numbers are marking the same or functionally the same characteristics. It shows in detail:

FIG. 1a stepped planetary gear in accordance with the state of the art

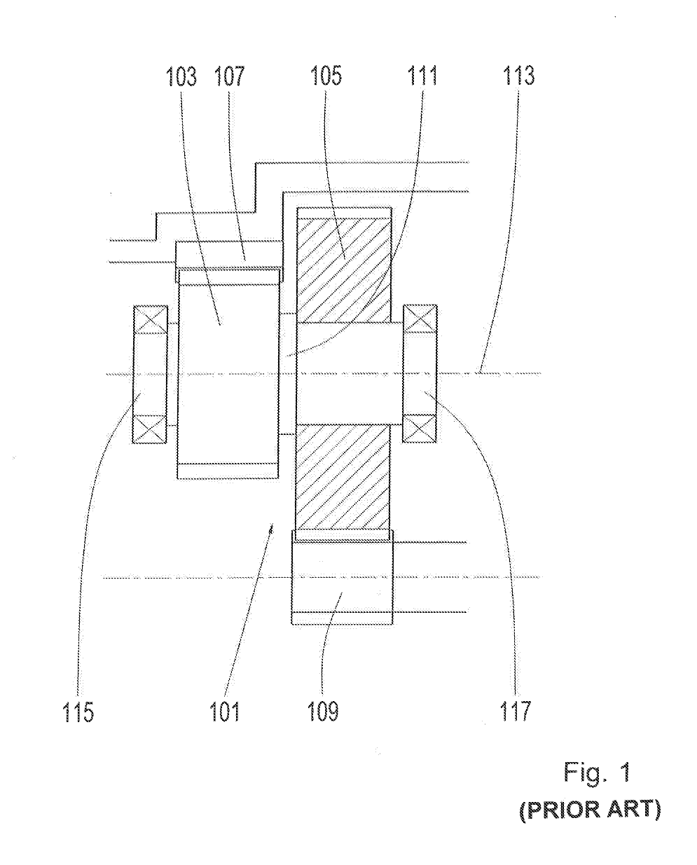

FIG. 2a a stepped planetary gear which is designed as one part with cylindrical roller bearings

FIG. 2b a stepped planetary gear which is designed as one part with tapered roller bearings

FIG. 3a a stepped planetary gear designed as two part with fitting spring and cylindrical roller bearings

FIG. 3b a stepped planetary gear designed as one part with fitting spring and tapered roller bearings

FIG. 4a a stepped planetary gear designed as two part with a flange connection and cylindrical roller bearings; and

FIG. 4b a stepped planetary gear designed as two part with a flange connection and tapered roller bearings,

### DETAILED DESCRIPTION OF THE PREFERRED EMBODIMENTS

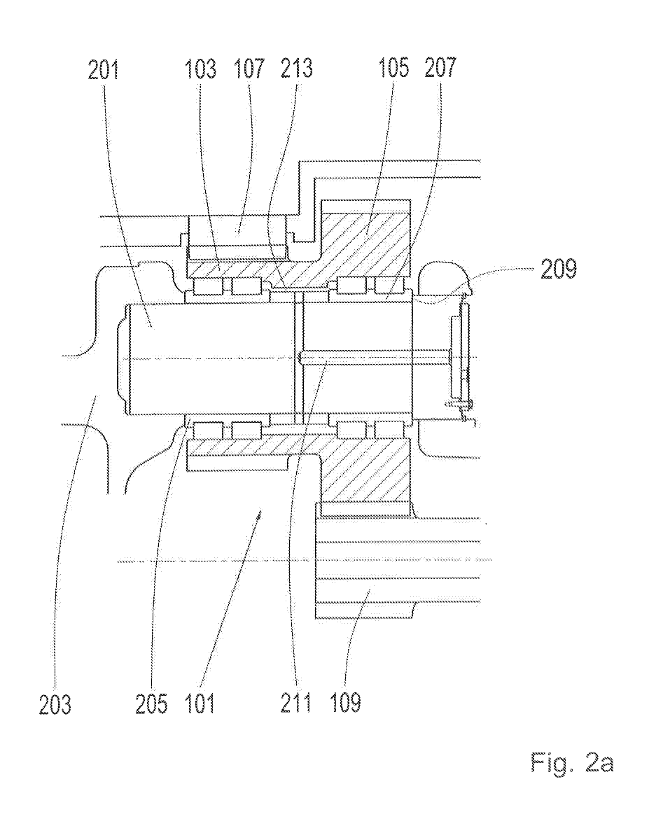

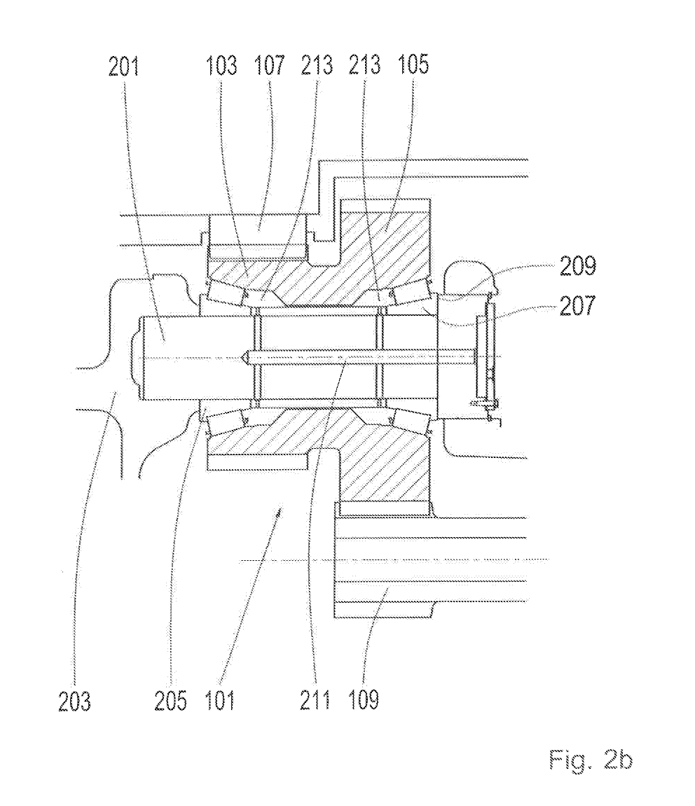

In the stepped planetary gear, in accordance with FIG. 2a, the first stepped gear 103 meshes with the ring gear 107. The second stepped gear 105 meshes with the sun gear 109.

The stepped planetary gear 101 is rotatably supported on a planetary bolt 201. In return, the planetary bolt 201 is fixed at both sides in the planetary carrier 203. In particular, the planetary carrier 203, through heating and a subsequent insertion of the planetary bolt 201 into the planetary carrier 203, can be shrunk to the planetary bolt 201.

A first planetary bearing 205 and a second planetary bearing 207 serve as the bearings of the stepped planetary gear 101 on the planetary bolt 201. The first planetary bearing 205 and the second planetary bearing 207 are each designed as a double-row cylindrical roller bearing.

Both bearings have an inner ring through which the planetary bolt 201 is passed, and which is fixed in the radial direction by the planetary bolt 201. In addition, the planetary bolt 201 is designed so as to fix the inner rings of the first planetary bearing 205 and a second planetary bearing 207 in the axial direction by means of a shoulder 209. In particular, the first planetary bearing 205 and the second planetary bearing 207 can be braced in the axial direction against each other by means of the shoulder 209,

A lubricant material duct 211 runs through the planetary bolt 201. It guides the lubricant material into a cavity 213, which is bounded by at least one of the two planetary bearings 205, 207. Therefore, the lubrication takes place of at least one of the two planetary bearings 205, 207.

In accordance with FIG. 2a, the cavity 213 is bounded by both the planetary bearing 205 as well as the second planetary bearing 207. Both planetary bearings 205, 207 are thus lubricated by one single cavity 213.

The stepped planetary gear 101 is designed as a one piece part. In particular, the first stepped gear 103, the second stepped gear 105, the outer bearing ring of the first planetary bearing 103 and the outer bearing ring of the second planetary bearing 207 are connected with each other as one piece. The stepped planetary gear 201 forms accordingly the outer bearing surface of the first planetary bearing 205 and the outer bearing surface of the second planetary bearing 207.

The first planetary bearing 205 and the second planetary bearing 207 are located in the inside of the stepped planetary gear 101. The stepped planetary gear 101 forms a hollow shaft. Accordingly, the first planetary bearing 205 and the second planetary bearing 207 are located inside of this hollow shaft. The first planetary bearing 205 and the second planetary bearing 207 are positioned in the axial direction in a way that, from each point of the first planetary bearing 205 and from each point of the second planetary bearing 207, a part of the stepped planetary gear is located on the outer side.

Different to FIG. 2a, the FIG. 2b shows an embodiment example of the stepped planetary gear 201 with a first planetary bearing 205, designed as a single-row tapered roller bearing, and a second planetary bearing 207, designed as a single-row tapered roller bearing . Two cavities 213 are provided for the lubrication of the two planetary carriers 205, 207, which are supplied with lubricant material through a lubricant material duct 211.

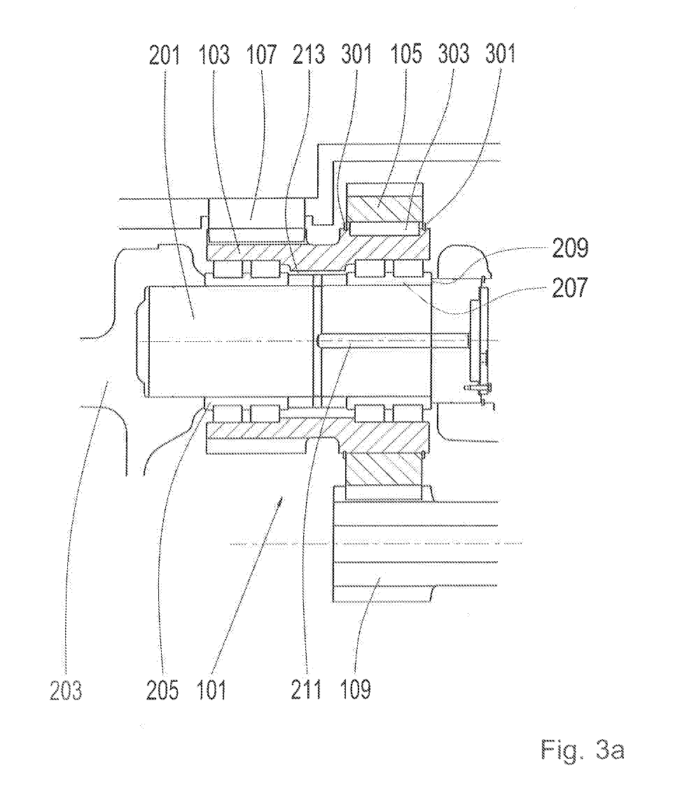

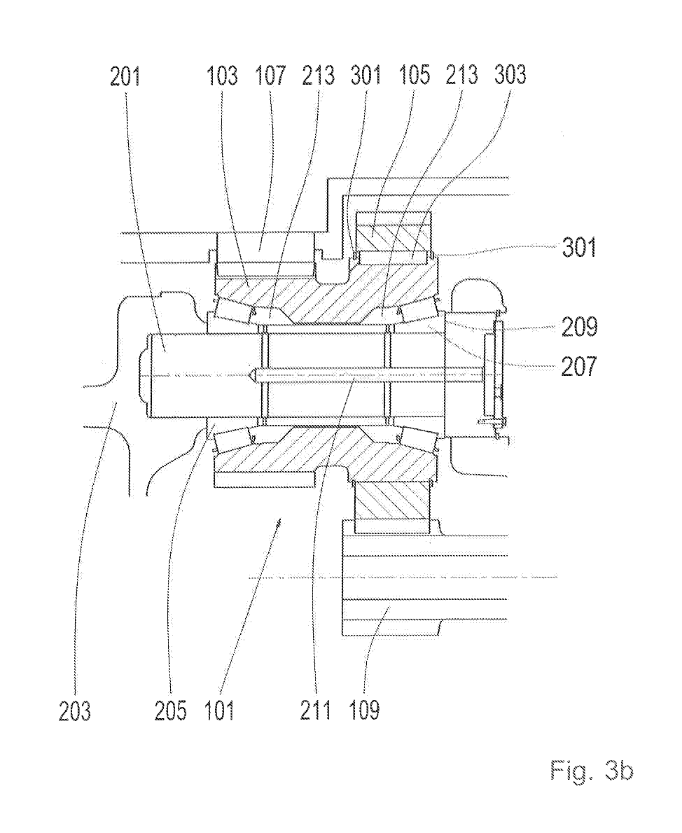

The stepped planetary gear 101, in accordance with FIG. 3a, is different from the stepped planetary gear 101 as shown in FIG. 2a by its two-piece design. The first piece of the stepped planetary gear 101 comprises the first stepped gear 103, the outer ring of the first planetary bearing 205, and the outer ring of the second planetary bearing 207. The second stepped gear 205 forms a second piece of the stepped planetary gear 101.

The stepped gear 105 can be pushed on to the first piece and is fixed gear by means of two locking rings 301 in the axial direction. Fixing of the second stepped gear 105 in the radial direction takes place through the first part. A fitting spring 303 serves the purpose of securing the second stepped gear 105 in regard to a torsion, relative to the first part.

The stepped planet 101, in accordance with FIG. 3b, differs from the stepped planetary gear 101 as shown in FIG. 3a by the fact that the first planetary bearing 205 and the second planetary bearing 207 are not designed as double-row cylindrical roller bearings, but as single-row tapered roller bearings. Different from FIG. 2b, the stepped planetary gear 101 in accordance with FIG. 3b is not designed as a single-piece part but—in accordance with FIG. 3a—but as a two piece part.

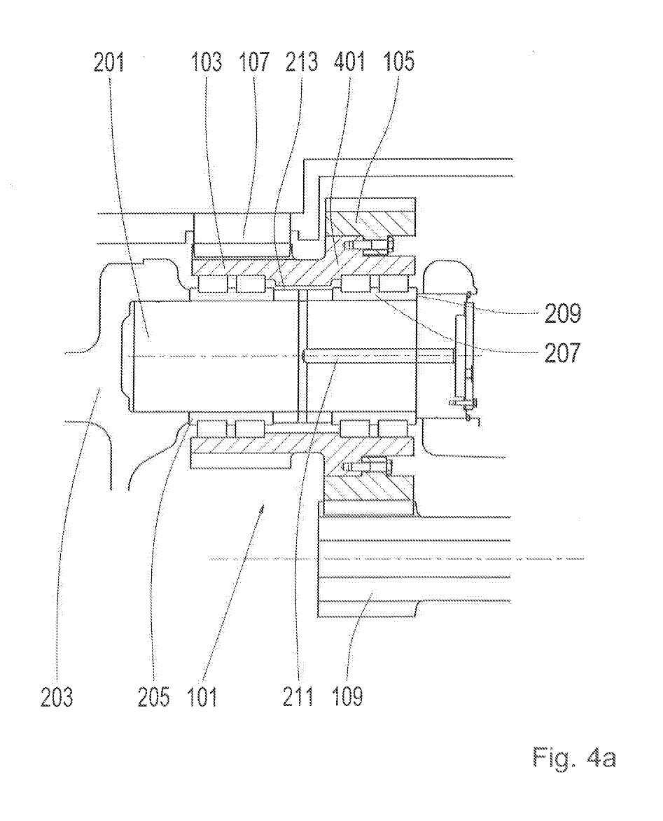

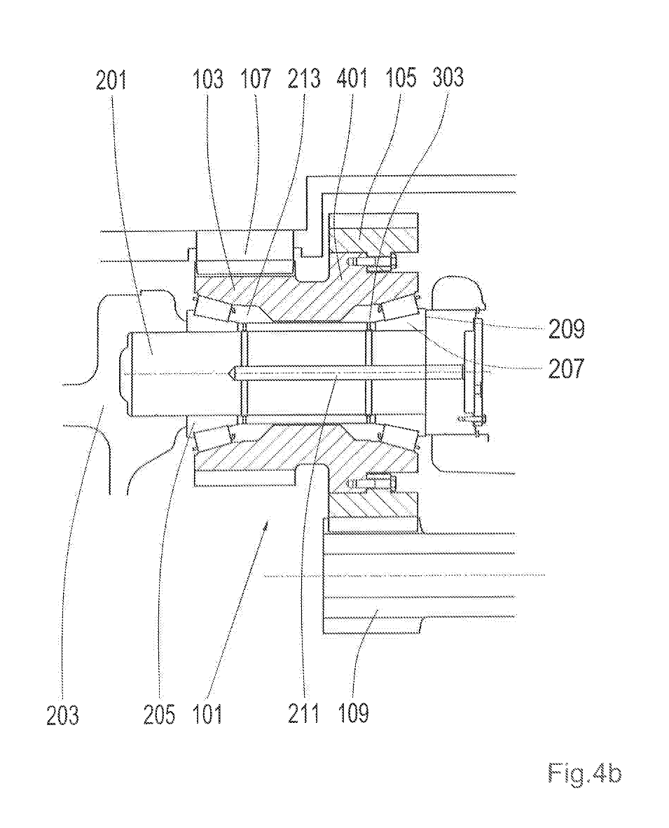

Like the stepped planetary gear 101 as shown in FIG. 3a and FIG. 3b, the stepped planetary gear 101 in accordance with FIG. 4a, is designed as a two-piece part. However, for fixing the second stepped gear 105, a flange 401 is provided instead of a fitting spring 303.

The flange 401, together with the first stepped gear 103, the outer bearing ring of the first planetary bearing 205, and the outer bearing ring of the second planetary bearing 207, forms a first piece of the two-piece designed step planetary 101. In accordance with FIG. 3a and FIG. 3b, the stepped gear 105 forms the second piece of the stepped planetary gear 101. The stepped gear 105 is screwed together with the flange 401.

The stepped planetary gear 101, as shown in FIG. 4b, differs from the stepped planetary gear 101 in FIG. 4a in such a way, that the first planetary bearing 205, and for the second planetary bearing 207 are not the double-row cylindrical roller bearings, but instead are single-row tapered roller hearings. Different from the stepped planetary gear in accordance with FIG. 3b, the stepped planetary gear as shown in FIG. 4b is not fixed by means of a fitting spring 303 and the first piece of the stepped planetary gear 101, but instead by screw connections of the flange 401.

### REFERENCE CHARACTERS

101 Stepped planetary gear

103 Stepped Gear

105 Stepped Gear

107 Ring Gear

109 Sun Gear

111 Planetary Shaft

113 Rotation Axis

115 Planetary Bearing

117 Planetary Bearing

201 Planetary Bolt

203 Planetary Carrier

205 Planetary Bearing

207 Planetary Bearing

209 Shoulder

211 Lubricant Duct

213 Cavity

301 Fixing Ring

303 Fitting Spring

401 Flange

1-7. (canceled)

8. A stepped planetary gear (101) comprising:
at least an outer bearing surface of a first planetary bearing (115),
the stepped planetary gear (101) being at least a partially hollow shaft, and
the outer bearing surface of the first planetary bearing (115) is at least partially positioned inside of the hollow shaft.

9. The stepped planetary gear (101) according to claim 7, further comprising at least an outer bearing surface of a second planetary bearing (117), and the outer bearing surface of the second planetary bearing (117) is at least partially position inside of the hollow shaft.

10. The stepped planetary gear (101) according to claim 8, wherein at least one of the outer bearing surface of the first planetary bearing (115) and the outer bearing surface of the second planetary bearing (117) are integrated into the hollow shaft as a single-piece part.

11. A planetary stage in combination with at least a stepped planetary gear (101) comprising:
at least an outer bearing surface of a first planetary bearing (115),
the stepped planetary gear (101) being at least a partially hollow shaft,
the outer bearing surface of the first planetary bearing (115) being partially positioned inside of the hollow shaft,
the stepped planetary gear having at least a planetary bolt (201), and
an inner ring of the first planetary bearing (115) being positioned on the planetary bolt (201).

12. The planetary stage in combination with the stepped planetary gear according to claim 11, wherein an inner ring of a second planetary bearing (117) is positioned on the planetary bolt (201).

13. The planetary stage in combination with the stepped planetary gear according to claim 11, wherein at least one of the inner ring of the first planetary bearing (115) and an inner ring of a second planetary bearing (117) is at least partially positioned inside of the hollow shaft.

14. The planetary stage in combination with the stepped planetary gear according to claim 11, wherein that the planetary bolt (201) has at least one duct (211) for supplying the first planetary bearing (117) with a lubricant.

15. A stepped planetary gear (101) comprising:
first and second stepped gears, and the first and the second stepped gears being rotationally and axially fixed relative to one another;
a bore extending fully axially through both the first and the second stepped gears and a planetary bolt being received within the bore of the first and the second stepped gears;
a first planetary bearing being at least partially received within the bore and comprising an inner bearing ring fixed relative to the planetary bolt, and an inner surface of the first stepped gear forming an outer bearing ring of the first planetary bearing which is rotatable with respect to the inner bearing ring of the first planetary bearing; and
a second planetary bearing being at least partially received within the bore and comprising an inner bearing ring fixed relative to the planetary bolt, and an inner surface of the second stepped gear forming an outer bearing ring of the second planetary bearing which is rotatable with respect to the inner bearing ring of the second planetary bearing.
